(19) United States
(12) Patent Application Publication
(10) Pub. No.: US 2021/0304282 A1
(43) Pub. Date: Sep. 30, 2021

(54) TERM LENGTH VARIABLE ACTION PREPARATION PLATFORM

(71) Applicant: BANK OF AMERICA CORPORATION, Charlotte, NC (US)

(72) Inventors: Katherine Dintenfass, Lincoln, RI (US); Paul Adam Keifer, Hudsonville, MI (US); Evelyn Varner, Hopkinton, MA (US); Jon David Neckes, Winchester, MA (US); Leslie Richard Rhyne, Bend, OR (US); Nina Greel, Framingham, MA (US); Amy Elizabeth Magazu, West Deptford, NJ (US); Karen DeLollis McLean, Winchester, MA (US)

(73) Assignee: BANK OF AMERICA CORPORATION, Charlotte, NC (US)

(21) Appl. No.: 16/835,969

(22) Filed: Mar. 31, 2020

(51) Int. Cl. G06Q 30/06; G06Q 30/02; H04L 29/08

(52) U.S. Cl. CPC G06Q 30/0631; G06Q 30/0201; H04L 67/20; H04L 67/22; G06Q 30/0623

(57) ABSTRACT

Embodiments of the invention are directed to a system, method, or computer program product for providing a temporal based platform for event action. In some embodiments, the platform is able to communicate and integrate into current applications for user activity interaction for action preparations. In this way, the system may integrate platform metrics into applications to generate an activities network based on temporal needs of a user event. Furthermore, the system may monitor the user utilization the activities and provide triggered responses based on the temporal event requirements. As such, the system may intervene within a known application or third party to provide triggered responses at variable term points based on user needs within an event.

### BACKGROUND

With advancements in technology, interactive application generation and deployment on to user devices is available in an array of industries. These interactive applications are generally provided and integrated within a single entity. However, a need exists for cross linking third party entity resources within an interactive application deployment.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for providing a term length variable action preparation platform.

Embodiments of the invention are directed to a system, method, or computer program product for providing a temporal based platform for event action. In some embodiments, the platform is able to communicate and integrate into current applications for user activity interaction for action preparations. In this way, the system may integrate platform metrics into applications to generate an activities network based on temporal needs of a user event. Furthermore, the system may monitor the user utilization the activities and provide triggered responses based on the temporal event requirements. As such, the system may intervene within a known application or third party to provide triggered responses at variable term points based on user needs within an event.

In some embodiments, the invention utilizes a platform for identification of user events and providing preparation actions to a user based on the temporal location of the user within the event. In this way, the system may generate activities for the user to perform in order to achieve milestones that are cross entity or from third parties. For example, the system may require the user to perform activities associated with a third party provided service or product, for a long term or short term portion of the user event.

Embodiments of the invention relate to systems, methods, and computer program products for temporal cross application performance platform deployment, the invention comprising: generating a temporal based platform for application generation or application integration, wherein the platform comprises variable activities for user presentation based on a temporal scale of a user event; implementing, upon user authorization, the temporal platform via a user device for presentation of the activities via a generated application or an integration of the activities onto a third party application; determining the user event associated with a user for temporal platform implementation; deploying activities on generated applications or integrated applications in a temporal manner, wherein the deployed activities are based on the user event; monitoring the user event based on short term and long term preparations required for the user event; and triggering modifications to activities based on variable change in a temporal status of the user event.

In some embodiments, the platform integrates into a third party application on the user device and presents activities for the user on the third party application.

In some embodiments, the invention further comprises providing tiered activities to the user, wherein the tiered activities are tiered based on temporal variation associated with the user event.

In some embodiments, determining the user event associated with a user for temporal platform implementation, further comprising identifying life events for the user, wherein the life events are identified by transaction history of the user and user application interaction inputs.

In some embodiments, activities include timed presentation and manipulation of generated application or integrated application based on the user event, wherein the activities include a required user manipulation of an application displayed on a user device display, triggered information on merchant products on the user device display, and financial temporal adjustment on the user display based on the user event.

In some embodiments, monitoring the user event based on short term and long term preparations required for the user event, further comprises monitoring a short or long term location of the user within the user event to identify products and services for user preparation of a phase of the user event.

In some embodiments, variable change in a temporal status of the user event further comprises a change in phase of the user event based on a passing of time.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a temporal based platform for event action system environment, in accordance with one embodiment of the present invention;

FIG. 2 provides a high level process flow illustrating integration and deployment the temporal platform cross entity and third party applications, in accordance with one embodiment of the present invention;

FIG. 3 provides a flow chart illustrating third party activity deployment, in accordance with one embodiment of the present invention; and

FIG. 4 provides a process map illustrating temporal monitoring and modification of the temporal platform, in accordance with one embodiment of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to a system, method, or computer program product for providing a temporal based platform for event action. In some embodiments, the platform is able to communicate and integrate into current applications for user activity interaction for action preparations. In this way, the system may integrate platform metrics into applications to generate an activities network based on temporal needs of a user event. Furthermore, the system may monitor the user utilization the activities and provide triggered responses based on the temporal event requirements. As such, the system may intervene within a known application or third party to provide triggered responses at variable term points based on user needs within an event.

As used herein, an “account” is the relationship that a user has with an entity and resources stored therein. The account is associated with and/or maintained by the entity. In some embodiments, as used herein the term “activity” may refer to any game, data presentation, product purchase, service purchase, product discount, movement to a location, or the like. In some embodiments, a “user event” may be an event happening in the life of a user that requires short term and long term preparation and planning. This includes relocating, career changes, having children, or the like.

As used herein, a “user” may be an entity customer or an individual that integrated or otherwise utilized the applications disclosed herein. A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software. In some embodiments, the term “platform” including the temporal platform may refer to a platform that is used as a base upon which other applications, processing, or technologies are distributed including applications, activities, integration into currently used applications, integration into systems, presentation of user interfaces, and the like.

Further, the embodiments described herein may refer to use of a transaction or transaction event. Unless specifically limited by the context, a “transaction” refers to any communication between the user and an entity. In some embodiments, for example, a transaction may refer to a purchase of goods or services, a return of goods or services, a payment transaction, a credit transaction, or other interaction involving a user's bank account. As further examples, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services; withdrawing cash; making payments to creditors; sending remittances; transferring balances from one account to another account; loading money onto stored value cards (SVCs) and/or prepaid cards; donating to charities; and/or the like.

In some embodiments, the system may integrate an activity performance cross entity platform that provides applications or integration into applications of an activities network. The platform allows for integration of activities and a user interface for the activities into known applications on a user device. Furthermore, in some embodiments, the system may monitor the user use of the activities integrated onto the known applications and the activities completed. As such, the system may intervene within a known application or third party. In some embodiments, the system may overlay a change or personalization within a third party application, such as providing special colored backgrounds to the application, presenting a symbol on the application, generating alternative backgrounds, or the like. Furthermore, the system may communicate with the third party and directly change the physical appearance of applications based on the same. As such, the system may intercept signals within an entity to change the look, color, or add a symbol to the user's application or the like.

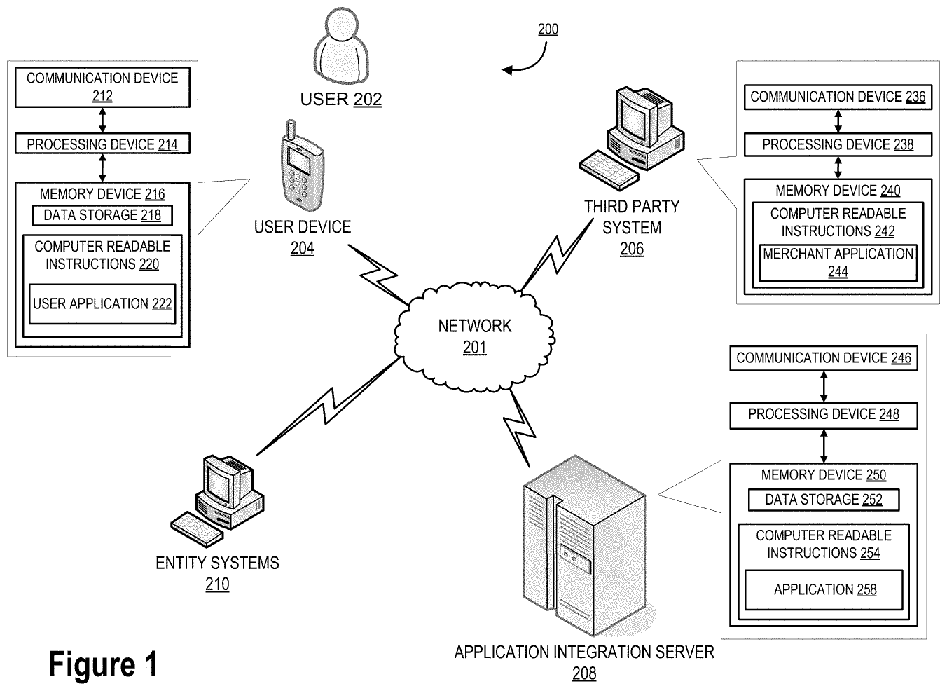

FIG. 1 provides a temporal based platform for event action system environment 200, in accordance with one embodiment of the present invention. As illustrated in FIG. 1, the application integration server 208 is operatively coupled, via a network 201 to the user device 204, to the third party system 206, and to entity systems 210. In this way, the application integration server 208 can send information to and receive information from the user device 204, the third party system 206, and the entity systems 210. FIG. 1 illustrates only one example of a cross entity application integration system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual that may download or otherwise utilize the application integration platform to perform one or more activities provided by the platform for temporal user event preparation.

As illustrated in FIG. 1, the application integration server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the third party system 206, the user device 204, and the entity systems 210. As such, the communication device 246 generally comprises a modem, server, or other device for communicating with other devices on the network 201.

As further illustrated in FIG. 1, the application integration server 208 comprises computer-readable instructions 254 stored in the memory device 250, which in one embodiment includes the computer-readable instructions 254 of an application 258. In some embodiments, the memory device 250 includes data storage 252 for storing data created and/or used by the application 258.

In the embodiment illustrated in FIG. 1 and described throughout much of this specification, the application 258 may perform the functions disclosed herein. In some embodiments, the application 258 may generate a temporal platform for term length variable action preparation. In this way, the application 258 may generate activities for the user 202 to perform based on the phase of the user in the user event.

For example, the application 258 may require the user 202 to perform activities associated with a third party system provided service or product, such as third parties associated with child care or the like. As such, the application 258 may provide offers to the user 202 to purchase one or more products such as child care, relocation care, or the like from a single resource distribution channel. The application 258 may then provide an associated offer for the resource distribution. In this way, the application 258 is matching the offer with the user 202 specific activities provided to the user across multiple entities.

In some embodiments, the application 258 may generate the platform with paths for the user 202. In this embodiment, the application 258 may provide simple information to other activities to the user 202 based on user selection from his/her user device 204 and based on the user event.

The user's 202 transaction data may be determined by the application 258. The user's 202 transaction data may comprise recent transactions or transaction history data. A financial institution may be uniquely situated to receive transaction data from a third party system 206 if the user 202 is utilizing a financial institution payment mechanism for a transaction. The financial institution may receive authentication data from the third party system 206 to authenticate the transaction of the user 202. This authentication data may be used by the application 258 such that the application 258 may further determine a current user event in real-time or close thereto and/or the potential for a future user event. For example, the system may identify that the user 202 is purchasing goods and services from a pet supply store in preparation for a new pet. In some embodiments, transaction history data may be received from the financial institution directly, other financial institutions, the user 202 directly, or the like and do not necessarily have to be established by information received from a point-of-transaction device. This transaction data may be stored within the financial institution, such that recent transactions as well as transaction history may be acquired by the application 258. In this way, the application 258 may determine the locations the user 202 likes to frequent, the merchants the user 202 typically purchases from, the history of transactions of the user 202, and the like to aid in determining appropriate offers to provide the user 202.

Furthermore the application 258 may further comprise an artificial intelligence (AI) or other type of intelligence program provided. In this way, the application 258 may analyze the user's 202 location data, transaction data, and activity data to make an intelligent, yet predicted trigger response recommendation for the user 202 for current and future user events.

As illustrated in FIG. 1, the third party system 206 generally comprises a reading device 235, a communication device 236, a processing device 238, and a memory device 240. The reading device 235 is operatively coupled to the processing device 238, communication device 236, and the memory device 240.

As further illustrated in FIG. 1, the third party system 206 comprises computer-readable instructions 242 stored in the memory device 240, which in one embodiment includes the computer-readable instructions 242 of a merchant application 244. A third party system 206 may refer to any device used at a third party location, such as logistics, inventory, entity status, to perform a transaction, either from the user's perspective, the merchant's perspective or both.

In some embodiments, a third party system 206 is or includes an interactive computer terminal that is configured to initiate, perform, complete, and/or facilitate one or more transactions. The third party system 206 as discussed herein may include any point of transaction device, such at a cash register, POS terminal, ATM, smart phone, back end server of a merchant, or the like. As such, the third party system 206 may be able perform a sale, an account balance check, a reward transfer, and account money transfer, a user 202 opening up a bank application on his mobile device or computer, a user 202 using his/her e-wallet, and/or the like.

In the embodiment illustrated in FIG. 1, the merchant application 244 allows the third party system 206 to be linked to the application integration server 208 to communicate, via a network 201, the information related to the transaction being made, such as the transaction type, cost of transaction, product type, merchant location, user 202 location, and the like. The merchant application 244 may also receive information from the application integration server 208. The merchant application 244, in some embodiments, may receive indication of a resulting trigger to present to a user 202 or the like.

FIG. 1 also illustrates a user device 204. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the third party system 206, the application integration server 208, and the entity systems 210. As such, the communication device 212 generally comprises a modem, server, or other device for communicating with other devices on the network 201.

As further illustrated in FIG. 1, the user device 204 comprises computer-readable instructions 220 stored in the memory device 216, which in one embodiment includes the computer-readable instructions 220 of a user application 222. In this way, a user 202 may be able to opt-in to the program, interact with the application, and/or the like using the user application 222. A “mobile device” 204 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 204 is depicted in FIG. 1, the payment account determination system environment 200 may contain numerous mobile devices 204.

The entity systems 210 are operatively coupled to the application integration server 208, the third party system 206, and/or the user device 204 through the network 201. The entity systems 210 have systems with devices the same or similar to the devices described for the application integration server 208, the third party system 206, and/or the user device 204 (i.e., communication device, processing device, and memory device). Therefore, the entity systems 210 communicate with the application integration server 208, the third party system 206, and/or the user device 204 in the same or similar way as previously described with respect to each system.

It is understood that the servers, systems, and devices described herein illustrate one embodiment of the invention. It is further understood that one or more of the servers, systems, and devices can be combined in other embodiments and still function in the same or similar way as the embodiments described herein.

Embodiments of the invention are directed to a system, method, or computer program product for providing a temporal based platform for event action. In some embodiments, the platform is able to communicate and integrate into current applications for user activity interaction for action preparations. In this way, the system may integrate platform metrics into applications to generate an activities network based on temporal needs of a user event. Furthermore, the system may monitor the user utilization the activities and provide triggered responses based on the temporal event requirements. As such, the system may intervene within a known application or third party to provide triggered responses at variable term points based on user needs within an event.

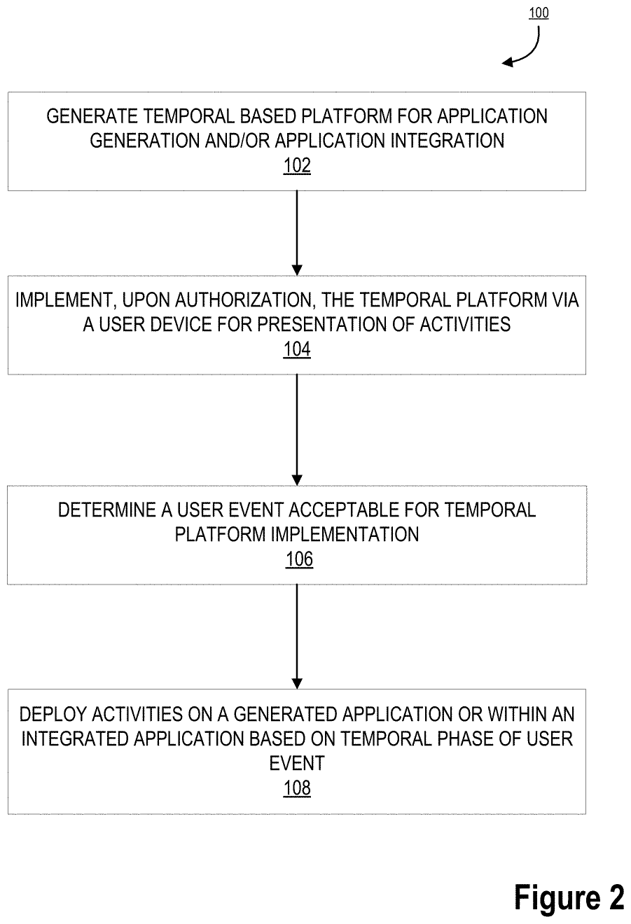

FIG. 2 illustrates a high level process flow illustrating integration and deployment the temporal platform cross entity and third party applications 100, in accordance with one embodiment of the present invention. As illustrated in block 102, the process 100 is initiated by generating a temporal based platform for application generation and/or application integration. As such, the temporal platform comprises data for temporal preparation of user events. This includes activities such as long term and short term information, product/service advice, product/service offers, programs, and other activities associated with a user event. User events may include events that occur in a user's life that may require long term and short term financial planning, product planning, and program planning. The platform may extract information from various sources associated with each possible user event and provide the financial planning, product planning, and program planning necessary to the user based on the user's specific user event.

As illustrated in block 104, the process 100 continues by implementing, upon authorization, the temporal platform via a user device for presentation of activities associated with the long term and short term financial planning, product planning, and program planning of a given user event. The temporal platform may integrate into existing applications on the user device or be a standalone application within the user device.

Next, as illustrated in block 106 the process 100 continues by determining a user event acceptable for temporal platform implementation. A user event acceptable for temporal platform implementation includes a user event that occur in a user's life that may require long term and short term financial planning, product planning, and program planning. This may include having children, marrying, getting a new pet, moving, or the like. Having children, for example may require short term planning, such as doctors planning, baby products, and the like while also requiring long term planning such as college savings, school planning, and the like. As such, the platform may identify these user events and determine a temporal point in the user event where the user currently exists.

In some embodiments, the platform may predict the user event associated with the user. This may be performed via machine learning based on a review of user transaction history. The system may identify the types of products/services and merchants the user transacts with to perform a machine learning predictor of user event status. In some embodiments, the user may authenticate into the platform and notify the platform of an upcoming user event that the user is expecting to occur.

As illustrated in block 108, the process 100 is completed by deploying activities on a generated application or within an integrated application based on the temporal phase of the user event. As such, the platform may determine the user, the user event associated with the user, and the temporal moment or phase of the user event that the user is currently in. At that point, the platform may extract the appropriate data, such as the appropriate long term and short term financial planning, product planning, and program planning for the phase of the user event that the user is currently experiencing in real-time.

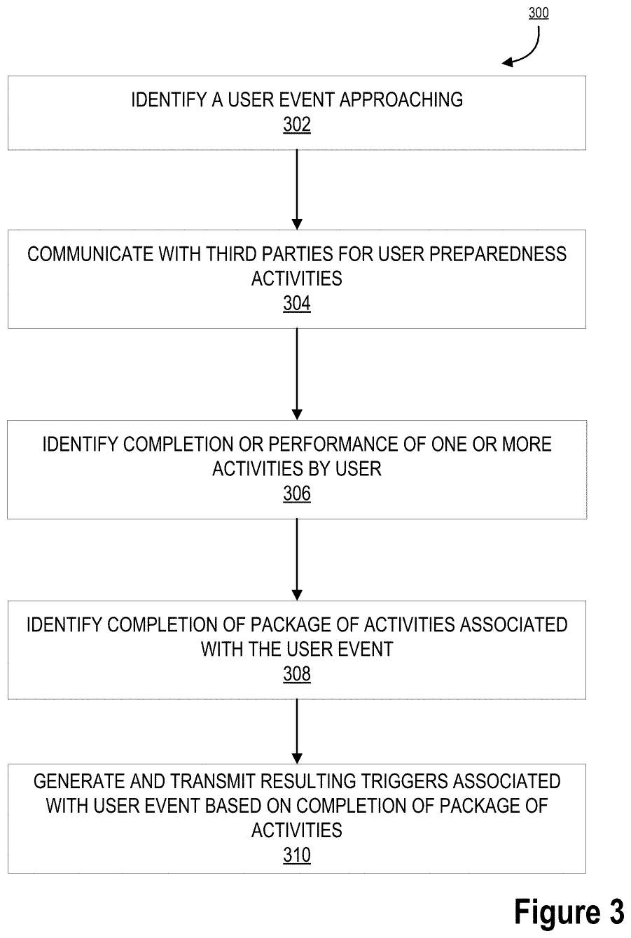

FIG. 3 illustrates a flow chart illustrating third party activity deployment 300, in accordance with one embodiment of the present invention. As illustrated in block 302, the process 300 identifies a user event approaching. A user event may include life events of the user described in further detail above. As such, the system may be communicably linked to a financial institution that may provide transaction history records to the system that may indicate one or more of the user events occurring in the future. As such, the system may identify the user purchasing items for a child or the like. In other embodiments, the user may notify the system of the occurrence of the event.

After the system has identified the user event approaching, the system may identify third party entities associated with the user event, as illustrated in block 304 where the process 300 continues by communicating with third parties for user preparedness activities specific for the user event. For example, if the user is flying to a destination, the system may identify third party entities associated with airports, airlines, car rental, hotels, restaurants, and the like. As such, the system identifies and gathers third party entities associated with the user event and communicates with those third parties. The system may identify activities associated with the third parties that the user may need to complete to obtain a resulting trigger. These activities may include going to a third party merchant, purchasing from a third party merchant, or the like. In some embodiments, the system provides offers based on cross entity activities completed by the user.

Next, as illustrated in block 306, the process 300 continues by identifying completion or performance of one or more activities by the user. The activities are integrated into the user device, such as from a platform generated application or integration within a current application the user may have on his/her user device. The platform, through the integration may monitor the user activity to determine if one or more activities have been completed by the user.

In some embodiments, the system may require the user to perform multiple activities to trigger a response reward. As such, the system may continue to store and monitor the user's progress through the activities. In this way, the system may further identify the completion of a package of activities associated with the user event, as illustrated in block 308.

Upon completion of the package of activities associated with the user event, the system may generate and transmit a resulting trigger response associated with the user event based on the completion of the package of activities, as illustrated in block 310. As such, upon identification of completion of the package of activities associated with the user event, the user may be rewarded with a resulting trigger. The resulting trigger may be information about a long term or short term phase of the user event, a product, server, or the like associated with or to be used during a portion of the event.

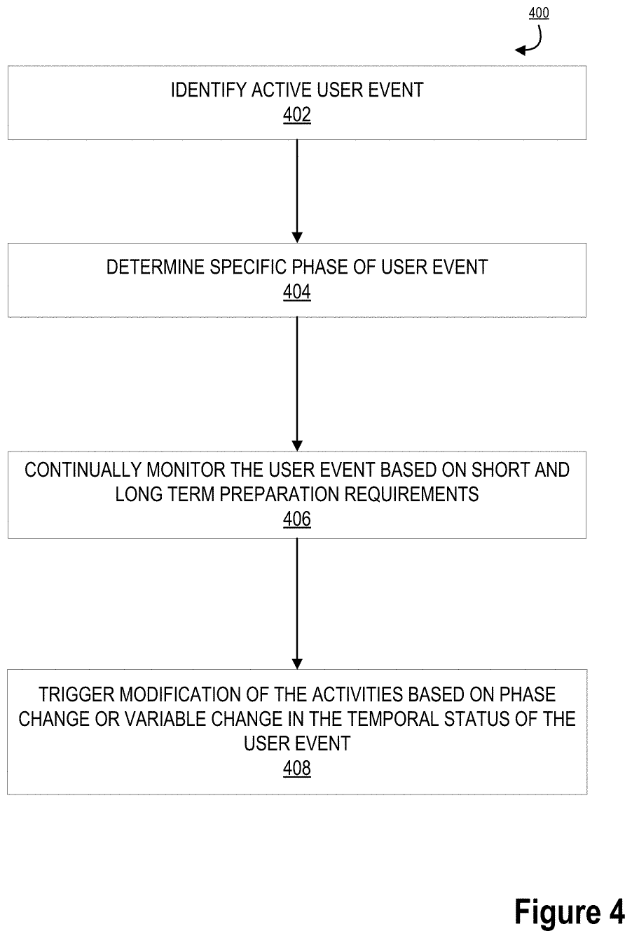

FIG. 4 illustrates a process map illustrating temporal monitoring and modification of the temporal platform 400, in accordance with one embodiment of the present invention. As illustrated in block 402, the process 400 is initiated by identifying an active user event. In this way, the platform may identify that a user is currently within one or more phases of a user event. The system may identify the phase of the user within the user event based on transaction history, social media posting, user input, or the like. Upon identification of the user within an active user event, the platform may further identify and determine the specific phase of the user event, as illustrated in block 404. In this way, the platform may identify along a sliding scale of potential phases of a user event the point in which the user is currently. This may be based on transaction history, user event start time, or the like.

As illustrated in block 406, the process 400 continues by continually monitoring the user event status based on long and short term preparation requirements for the user event. As such, the platform may identify the activities the user is currently preforming and provide an interactive indication of upcoming activities and/or recommendations based on the same.

Finally, as illustrated in block 408, the process 400 is completed by triggering a modification of the activities based on an identified phase change or a variable change in the temporal status of the user event. In this way, the user may have progressed to a subsequent stage, had a variable change that required delay or hold of the phase, or the like. As such, the platform provides a continual real-time term length variable action preparation platform for user event preparation.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for temporal cross application performance platform deployment, the system comprising:
a memory device with computer-readable program code stored thereon;
a communication device;
a processing device operatively coupled to the memory device and the communication device, wherein the processing device is configured to execute the computer-readable program code to:
generate a temporal platform for application generation or application integration, wherein the platform comprises variable activities for user presentation based on a temporal scale of a user event;
implement, upon user authorization, the temporal platform via a user device for presentation of the activities via a generated application or an integration of the activities onto a third party application;
determine the user event associated with a user for temporal platform implementation;
deploy activities on generated applications or integrated applications in a temporal manner, wherein the deployed activities are based on the user event;
monitor the user event based on short term and long term preparations required for the user event; and
trigger modifications to activities based on variable change in a temporal status of the user event.

2. The system of claim 1, wherein the platform integrates into a third party application on the user device and presents activities for the user on the third party application.

3. The system of claim 1, further comprising providing tiered activities to the user, wherein the tiered activities are tiered based on temporal variation associated with the user event.

4. The system of claim 1, wherein determining the user event associated with a user for temporal platform implementation, further comprising identifying life events for the user, wherein the life events are identified by transaction history of the user and user application interaction inputs.

5. The system of claim 1, wherein activities include timed presentation and manipulation of generated application or integrated application based on the user event, wherein the activities include a required user manipulation of an application displayed on a user device display, triggered information on merchant products on the user device display, and financial temporal adjustment on the user display based on the user event.

6. The system of claim 1, wherein monitoring the user event based on short term and long term preparations required for the user event, further comprises monitoring a short or long term location of the user within the user event to identify products and services for user preparation of a phase of the user event.

7. The system of claim 1, wherein variable change in a temporal status of the user event further comprises a change in phase of the user event based on a passing of time.

8. A computer program product for temporal cross application performance platform deployment, the computer program product comprising at least one non-transitory computer-readable medium having computer-readable program code portions embodied therein, the computer-readable program code portions comprising:
an executable portion configured for generating a temporal platform for application generation or application integration, wherein the platform comprises variable activities for user presentation based on a temporal scale of a user event;
an executable portion configured for implementing, upon user authorization, the temporal platform via a user device for presentation of the activities via a generated application or an integration of the activities onto a third party application;
an executable portion configured for determining the user event associated with a user for temporal platform implementation;
an executable portion configured for deploying activities on generated applications or integrated applications in a temporal manner, wherein the deployed activities are based on the user event;
an executable portion configured for monitoring the user event based on short term and long term preparations required for the user event; and
an executable portion configured for triggering modifications to activities based on variable change in a temporal status of the user event.

9. The computer program product of claim 8, wherein the platform integrates into a third party application on the user device and presents activities for the user on the third party application.

10. The computer program product of claim 8, further comprising an executable portion configured for providing tiered activities to the user, wherein the tiered activities are tiered based on temporal variation associated with the user event.

11. The computer program product of claim 8, wherein determining the user event associated with a user for temporal platform implementation, further comprising identifying life events for the user, wherein the life events are identified by transaction history of the user and user application interaction inputs.

12. The computer program product of claim 8, wherein activities include timed presentation and manipulation of generated application or integrated application based on the user event, wherein the activities include a required user manipulation of an application displayed on a user device display, triggered information on merchant products on the user device display, and financial temporal adjustment on the user display based on the user event.

13. The computer program product of claim 8, wherein monitoring the user event based on short term and long term preparations required for the user event, further comprises monitoring a short or long term location of the user within the user event to identify products and services for user preparation of a phase of the user event.

14. The computer program product of claim 8, wherein variable change in a temporal status of the user event further comprises a change in phase of the user event based on a passing of time.

15. A computer-implemented method for temporal cross application performance platform deployment, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
generating a temporal platform for application generation or application integration, wherein the platform comprises variable activities for user presentation based on a temporal scale of a user event;
implementing, upon user authorization, the temporal platform via a user device for presentation of the activities via a generated application or an integration of the activities onto a third party application;
determining the user event associated with a user for temporal platform implementation;
deploying activities on generated applications or integrated applications in a temporal manner, wherein the deployed activities are based on the user event;
monitoring the user event based on short term and long term preparations required for the user event; and
triggering modifications to activities based on variable change in a temporal status of the user event.

16. The computer-implemented method of claim 15, wherein the platform integrates into a third party application on the user device and presents activities for the user on the third party application.

17. The computer-implemented method of claim 15, further comprising providing tiered activities to the user, wherein the tiered activities are tiered based on temporal variation associated with the user event.

18. The computer-implemented method of claim 15, wherein determining the user event associated with a user for temporal platform implementation, further comprising identifying life events for the user, wherein the life events are identified by transaction history of the user and user application interaction inputs.

19. The computer-implemented method of claim 15, wherein activities include timed presentation and manipulation of generated application or integrated application based on the user event, wherein the activities include a required user manipulation of an application displayed on a user device display, triggered information on merchant products on the user device display, and financial temporal adjustment on the user display based on the user event.

20. The computer-implemented method of claim 15, wherein monitoring the user event based on short term and long term preparations required for the user event, further comprises monitoring a short or long term location of the user within the user event to identify products and services for user preparation of a phase of the user event.
